(19) United States
(12) Patent Application Publication
(10) Pub. No.: US 2012/0101987 A1
(43) Pub. Date: Apr. 26, 2012

(54) DISTRIBUTED DATABASE SYNCHRONIZATION

(76) Inventors: Paul Allen Bottorff, Portola Valley, CA (US); Charles L. Hudson, Round Rock, TX (US); Michael R. Krause, Boulder Creek, CA (US)

(21) Appl. No.: 12/911,356

(22) Filed: Oct. 25, 2010

(51) Int. Cl. G06F 17/30

(52) U.S. Cl. 707/610; 707/E17.005

(57) ABSTRACT

Systems and methods of fast synchronization failure detection in distributed databases are disclosed. An example of a method includes receiving a digest of a database stored at a sending node in a network, the digest broadcast by the sending node to N number of nodes in the network. The method also includes generating a digest of a database stored at a receiving node in the network. The method also includes comparing the generated digest to the received digest. The method also includes issuing a lost synchronization signal by the receiving node when the comparison indicates a change in the database stored at the sending node.

### BACKGROUND

With the rise of virtual machines, the amount of information needed by bridges and other components in the communications (e.g., Ethernet) network about the other components in the network is increasing. In order to manage this information, many of the network components utilize data stores or databases. These databases are continually evolving during network use, with individual records changing and the overall database expanding in size.

When records in a database change, those changes are transmitted to each of the network components so that the network components can update their databases to reflect these changes. However, there is no guarantee that all of the information arrives intact at each of the network components. That is, retransmissions, flow control protocols, waiting in queues, and other communication glitches may result in imperfect transmission of the database updates. Over time, the databases at one or more of the network components may “walk out of synch.”

Accordingly, the entire database may be retransmitted in its entirety at various intervals. However, the database may still be out of synchronization in between retransmission of the entire database. In addition, transmitting large databases for a large number of network components can unacceptably degrade network performance by “dominating the wire” during transmission.

### BRIEF DESCRIPTION OF THE DRAWINGS

FIG. 1 is a high-level illustration of an example network which may be implemented for fast synchronization failure detection in distributed databases.

FIGS. 2a-c are examples of data structures which may be used for fast synchronization failure detection in distributed databases.

FIG. 3 illustrates an example of generating a digest of a database.

FIGS. 4a-d are ladder diagrams illustrating digest protocols.

FIGS. 5a-b are state diagrams illustrating fast synchronization failure detection in distributed databases.

FIG. 6 is a flowchart illustrating example operations which may be implemented for fast synchronization failure detection in distributed databases.

### DETAILED DESCRIPTION

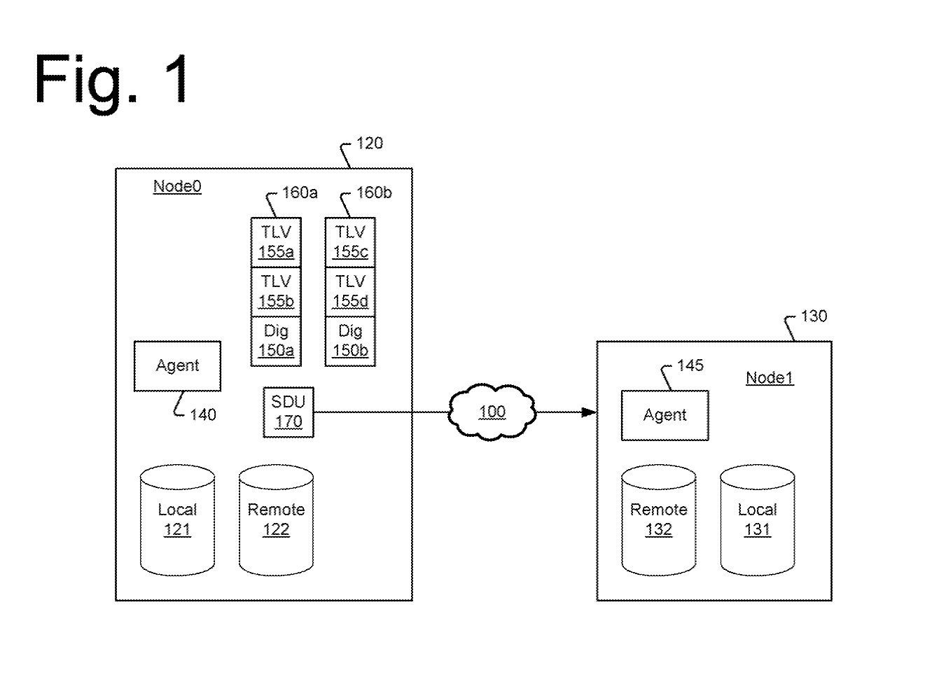

FIG. 1 is a high-level illustration of an example network 100 which may be implemented for fast synchronization failure detection in distributed databases. The network 100 may be implemented in one or more communication networks, such as an Ethernet local area network (LAN), and includes a plurality of nodes. In the example shown in FIG. 1, the nodes include at least one node 120 (e.g., node0) and at least one other node 130 (e.g., node1). For example, node 120 may be a station node or a bridge node, and node 130 may be a station node or a bridge node. It is noted, however, that an actual network may include many bridge nodes and/or station nodes, along with other network devices.

The nodes 120 and 130 may include at least some processing capability such as a processor and computer-readable storage for storing and executing computer-readable program code for facilitating communications in the network 100 and managing at least one database, such as a local database 121, 131 and a remote database 122, 132. The nodes 120 and 130 may also provide services to other computing or data processing systems or devices in the network 100. For example, the nodes 120 and 130 may also provide transaction processing services, etc.

The nodes 120 and 130 may be provided on the network 100 via a communication connection, and refers to devices used in packet-switched computer networks, such as an Ethernet network. However, the systems and methods described herein may be implemented in other level 2 (L2) networks and are not limited to use in Ethernet networks.

As used herein, a “bridge node” or “bridge” is a device that connects two networks that may use the same or a different Data Link Layer protocol (e.g., Layer 2 of the OSI Model). Bridges may also be used to connect two different networks types, such as Ethernet and Token Ring networks.

A network bridge connects multiple network segments at the data link layer. A bridge node includes ports that connect two or more otherwise separate LANs. The bridge receives packets on one port and retransmits those packets on another port. The bridge node does not retransmit a packet until a complete packet has been received, thus enabling station nodes on either side of the bridge node to transmit packets simultaneously.

The bridge node manages network traffic. That is, the bridge node analyzes incoming data packets before forwarding the packet to another segment of the network. For example, the bridge node reads the destination address from every packet coming through the bridge node to determine whether the packet should be forwarded based on information included in the local and/or remote databases (e.g., databases 121, 122 if node 120 is a bridge node), for example, so that the bridge does not retransmit a packet if the destination address is on the same side of the bridge node as the station node sending the packet. The bridge node builds the databases by locating network devices (e.g., node 130) and recording the device address.

In the example shown in FIG. 1, the databases are feature databases. Each node in the network includes at least one local (or “shared”) feature database for information about the node itself. The term shared is used herein to refer to the data in the database that represents the information about the node itself and is advertised to all other nodes. The local database for this node becomes a remote database within the other nodes. Each node in the network also includes at least one remote (or “private”) feature database for information about other nodes and/or devices in the network. The term private is used herein to describe data that is not transmitted by the node, but instead represents the current view of the database from some specific remote node (this is the distributed image of some other nodes local database). The remote database at each node is an N-way database with database entries for each of the N number of nodes and/or devices a particular node “sees” in the network 100.

In an embodiment, the database entries are formatted in Type Length Value (TLV) encoding. TLV is an example data type, a structure which enables the addition of new parameters to Short Message Peer to Peer (SMPP) Protocol Data Unit (PDU). TLV parameters are included in the SMPP protocol (versions 3.4 and later). The TLVs specified herein include a two octet header with five bits of type and eleven bits of length and in this example, are specific to the embodiments described herein. The TLVs can be added as a byte stream in a standard SMPP PDU. A PDU is a packet of data passed across a network. A Service Data Unit (SDU) is a set of data that is transmitted to a peer service, and is the data that a certain layer will pass to the layer below. The PDU specifies the data that will be sent to the peer protocol layer at the receiving end. The PDU at one layer, ‘n’, is the SDU of the layer below, ‘n-1’. In effect the SDU is the payload of a PDU.

During operation, the Upper Layer Protocol (ULP) delivers the TLVs to the shared feature database at the node 120. Each node has a private database and uses a TLV service interface rather than direct access to the shared feature database to enter TLVs. When a new TLV is received from the local ULP, a database agent 140 at the node 120 checks to see if the TLV is new. TLV new is obscure. The agent checks to see if the new TLV changes any information within the database. The TLV may reference an existing TLV, however may have some changed information from the existing TLV. If the TLV is new, then a TLV digest 150a-b is calculated and a transmit flag is set. The calculation for a new TLV adds the new TLV digest to the database digest. However if the TLV is an update (change of an already existing digest), then the old TLV digest is subtracted from the database digest, and then the new TLV digest is added.

Periodically, the database agent 140 collects all the new or changed TLVs 155a-d from the local database, and packs these TLVs 155a-d in as many PDUs 160a-b as needed and delivers the PDUs 160a-b one at a time as the SDU (e.g., SDU 170 is shown being broadcast in FIG. 1). The deleted TLV case is handled specially with the Void and uses different processing. The three cases are: new TLV, changed TLV, and delete (or void) TLV. The database agent 140 also sends its own local database digest TLV.

When the node 130 receives a PDU 160a-b, the database agent 145 at the node 130 checks and acknowledges (ACK) receipt of each PDU 160a-b. The database agent 145 then extracts the TLVs 155a-d and compares the received TLVs 155a-d with the TLVs of the remote database 132 at the node 130. If the database agent 145 finds new or changed TLVs 155a-d, the digest is updated. The database agent 145 also receives and processes digest checks and voids.

Accordingly, only the updated TLVs are transmitted “over the wire”, rather than sending the entire database 121. This removes constraints on database size, speed, and reliability, and is particularly advantageous in distributed networks where the entire updated database would otherwise have to be transmitted to each of the other nodes in the network.

In order that only the updated TLVs need to be transmitted, each database record on a local node (e.g., node 120) is assigned a key locally, and the key is distributed to all remote nodes (e.g., node 130) in the network 100. The key may be a flat 16 bit (or other suitable length) integer enabling the database to contain up to 64K TLVs (or other corresponding number, depending on the key length). The range of the key may be configured with the same value on both the node 120 and the node 130. Unlike Link Layer Discovery Protocol (LLDP), the key may be dynamically assigned and then shared between the local and remote databases. The ULPs manipulating database elements use the primary key for all TLV operations. Available keys are assigned to the ULPs and may be in possession of the ULP until the ULP releases the key.

Before continuing, it is noted that dynamically directing traffic through the multiple paths in a routable fabric, as just described, is for purposes of illustration and is not intended to be limiting. In addition, other functional components may also be provided and are not limited to those shown and described herein.

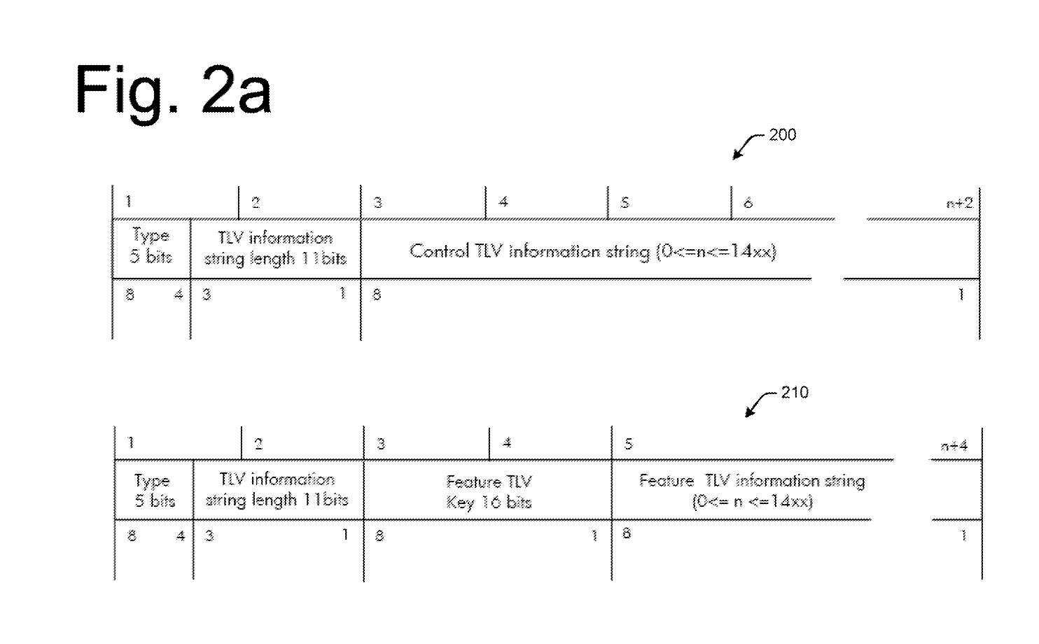

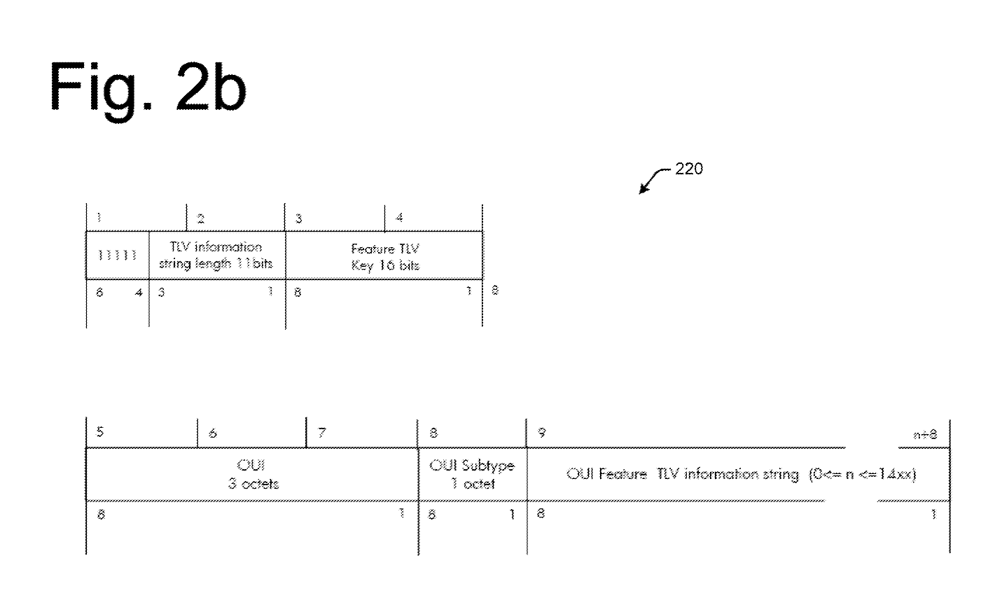

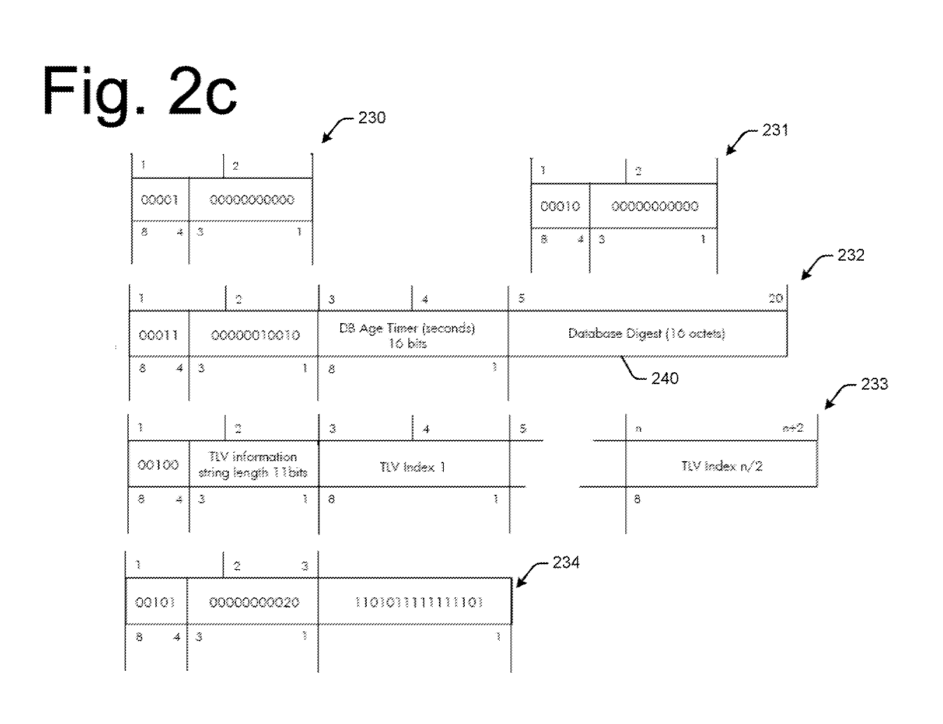

FIGS. 2a-c are examples of data structures which may be used for fast synchronization failure detection in distributed databases. The data structures shown are TLV format, consistent with the example described above for FIG. 1. It is noted, however, that any suitable data structures may be utilized, and the systems and methods described herein are not limited to use with the TLV format.

That being said, FIG. 2a shows an example of a Control TLV 200 and a Feature TLV 210. Type 1 is a LostSync TLV; Type 2 is a Sync TLV; Type 3 is a Dig TLV; Type 4 is a Void TLV; Type 5 is an End; Type 8-30 are defined feature type identifiers, and Type 31 is a feature type identifier. The length in octets may not exceed the maximum frame size due to PDU overheads. The feature TLV 210 may include a 16 bit primary key for each database element.

FIG. 2b shows an example of organization-specific TLV 220, which includes a 3 octet organization identifier, and unique identifier subtype. It is noted that the example TLV shown in FIG. 2b may be implemented as an alternative embodiment to the TLVs shown in FIG. 2a.

FIG. 2c shows examples of ULP control TLVs. Shown in this example are: LostSync TLV 230, Sync TLV 231, Digest TLV 232, Void TLV 233, End TLV 234. It is noted that the database digest is shown in Digest TLV 232 in field 240. The digest is a summary of the entire database (which may be as large as many megabytes or more) after having been compressed to 16 octets in this example.

It is noted that both the local and remote databases are keyed with an index with a maximum value negotiated between the station node and the bridge node. For example, index values between 0 and 127 are reserved for TLVs, while the rest of the available index values are dynamically assigned to ULPs.

For each TLV, the database also has five local variables. These are the Valid Boolean, Stale/Void Boolean, Touched Boolean, Changed Boolean, and the TLV hash. A single digest variable exists for each database. Every database TLV is keyed with an index. This index is known to the ULP and used by the ULP for access to the TLV. The Boolean arrays are not visible to the ULP.

The Valid Boolean array indicates the presence or absence of a valid TLV on the index.

The Stale/Void Boolean array is set to True for all valid TLVs for the remote database whenever the database has lost sync. The Stale variable is set to False whenever the TLV is updated. For the local database, True is set for TLVs whenever they are voided from the database.

The Touched Boolean array is set to False every time the database TLV lease time expires, and set to True whenever the TLV is updated. The ULP is responsible for updating TLVs.

The Changed Boolean array is set to True to indicate the TLV was updated with a change in content, and set to False if the TLV has not changed since the last time the TLV was received (remote database) or transmitted (local database).

The TLV hash array is the digest calculation (e.g., SHA-256 truncated to 128 least significant bits for the current TLV).

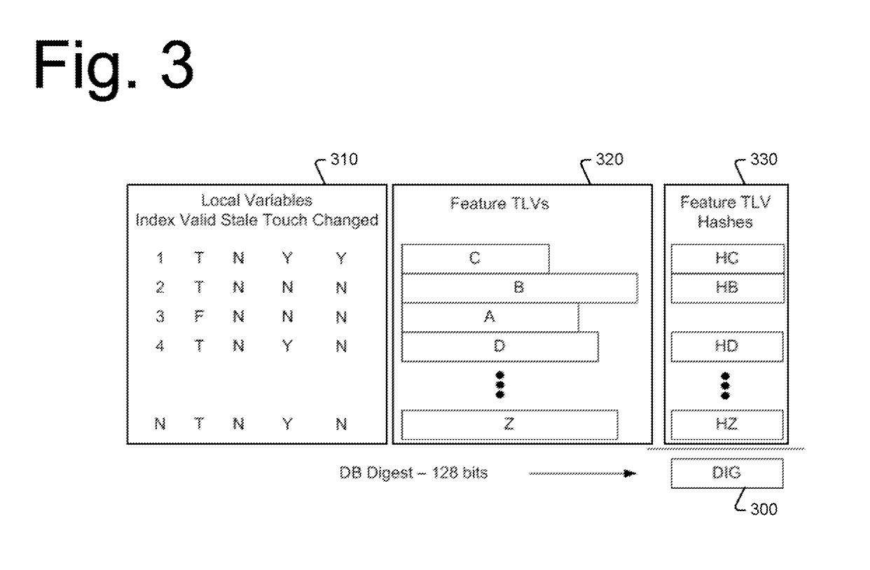

FIG. 3 illustrates an example of generating a digest 300 of a database. Digest 300 may be based on one or more records in a feature database. In this example, the local variables Valid, Stale, Touch, and Changed are illustrated in table 310. Each record 320 in the feature database is hashed to generate feature hashes 330 for each record 320. Then each of the hashes 330 are XOR'ed to generate the digest 300.

In an example, a high quality digest may be based on a cryptographic hash function, such as but not limited to, SHA-256, MD5, or other suitable algorithm. Also in an example, the records are hashed as TLVs to generate individual feature TLV hashes for each of the TLVs. The feature TLV hashes are then XOR'ed to generate a 128 bit truncated database digest 300.

The hash 300 includes a hash of all TLV fields. The digest 300 may be generated in hardware and/or program code (e.g., firmware or software). The digest 300 is order independent, supports incremental updates, and supports any size database. The digest 300 also enables incremental calculations. Each TLV hash may be generated as updates to the TLV arrive. Deleting a TLV may be by a single XOR. Adding a TLV may be by hashing a single TLV and a single XOR. Updating a TLV may be by hashing a single TLV and two XORs. Again, it is noted that while TLVs are used in the example shown in FIG. 3, the systems and methods described herein are not limited to any particular format.

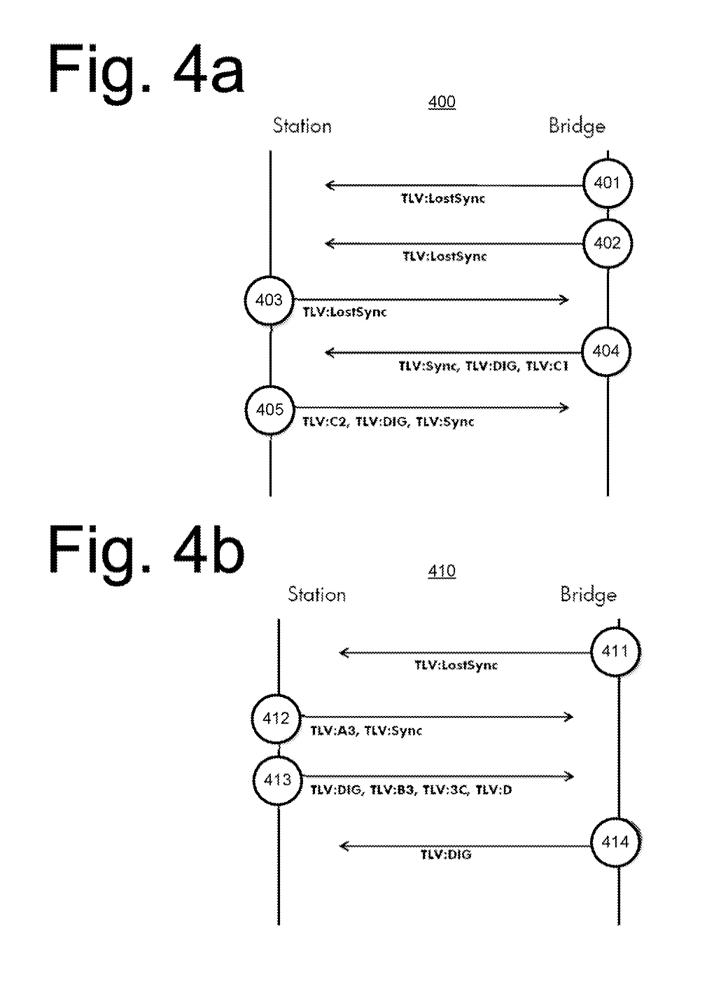

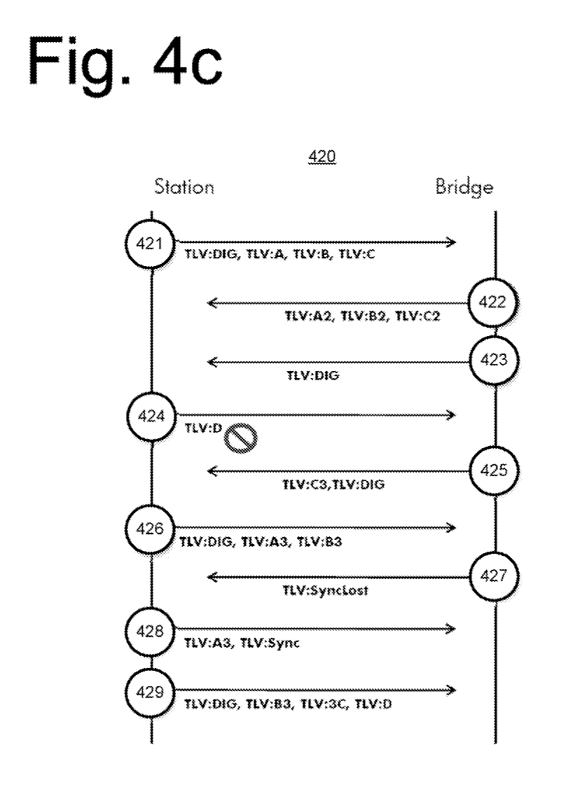

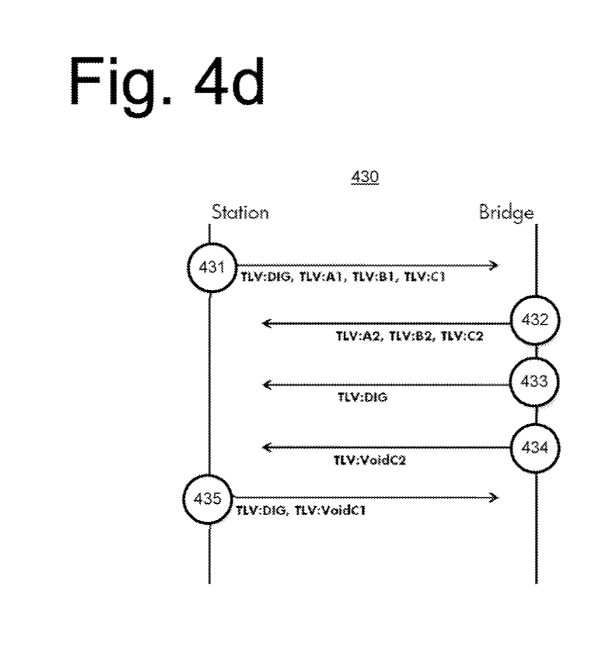

FIGS. 4a-d are ladder diagrams 400, 410, 420, and 430, respectively, illustrating digest protocols. It is noted that while only one station node and one bridge node are shown in FIGS. 4a-d, any number of stations and/or bridges may be present, and the communications illustrated by ladder diagrams 400, 410, 420, and 430 by be implemented by N number of elements wherein N is the number of nodes.

The example in FIG. 4a shows a normal startup dialog 400. In this example, the database agent at the bridge node sends a TLV (e.g., Sync) at 401 and 402 until a TLV is received from the station node. The database agent at the station node sends a TLV (e.g., Sync) at 403. When the bridge node receives a TLV, the database agent begins at 404; and when the station node receives a TLV, the database agent begins at 405.

The example in FIG. 4b shows a restart dialog 410. In this example, the database agent at the bridge node sends a TLV (e.g., LostSync) at 411 until a TLV is received from the station node. The database agent at the station node sends a TLV (e.g., Sync) at 412 and a database update at 413. When the bridge node receives a TLV and digest, the database agent begins running normal at 414.

The example in FIG. 4c shows a basic dialog 420. In this example, the database agent at the station node sends a TLV at 421 to the bridge node. The database agent at the bridge node sends a TLV at 422 and a digest at 423. If the station node loses the PDU at 424, the bridge node has not seen the loss at the station node. The bridge node sends a digest at 425. The digest sent from the station node at 426 does not match the bridge digest, so the bridge node sends a SyncLost TLV at 427. At 428 and 429, the station node and the bridge node resynchronize.

The example in FIG. 4d shows a dialog 430 voiding a TLV from the database. In this example, the database agent at the station node sends a TLV at 431 to the bridge node (normal TLV exchange). The database agent at the bridge node sends a TLVs at 432-434, wherein the bridge node voids an entry C2. The station sees the voided entry for C2. At 435, the station node voids C1 and deletes the TLV, and the bridge node sees the Void for C1 and deletes the TLV. If for instance 434 is lost the digest at 435 will not match and the machines will move to the lost sync process in 420.

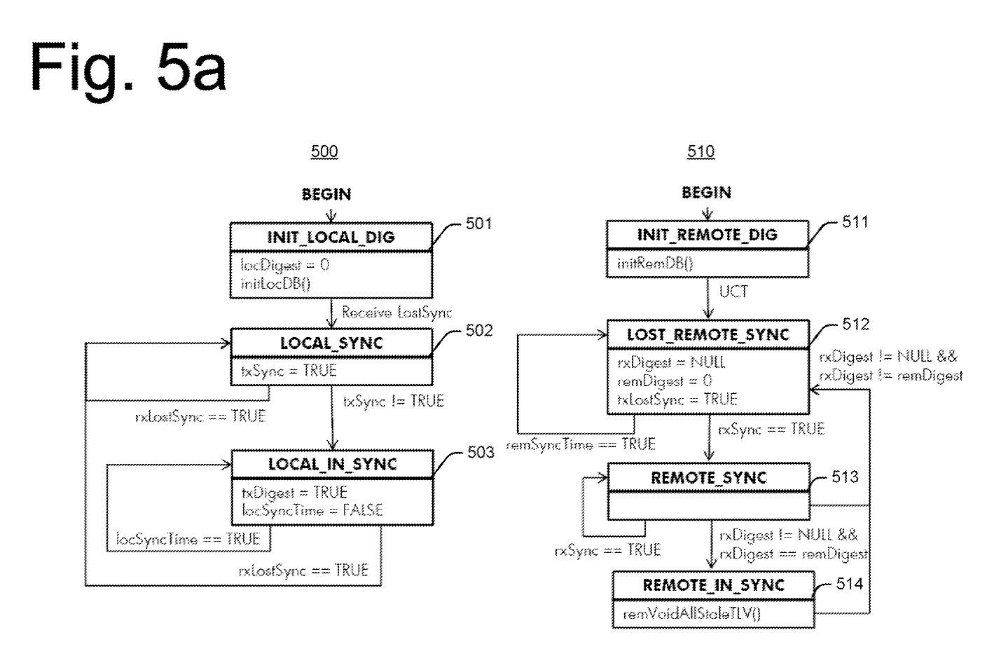

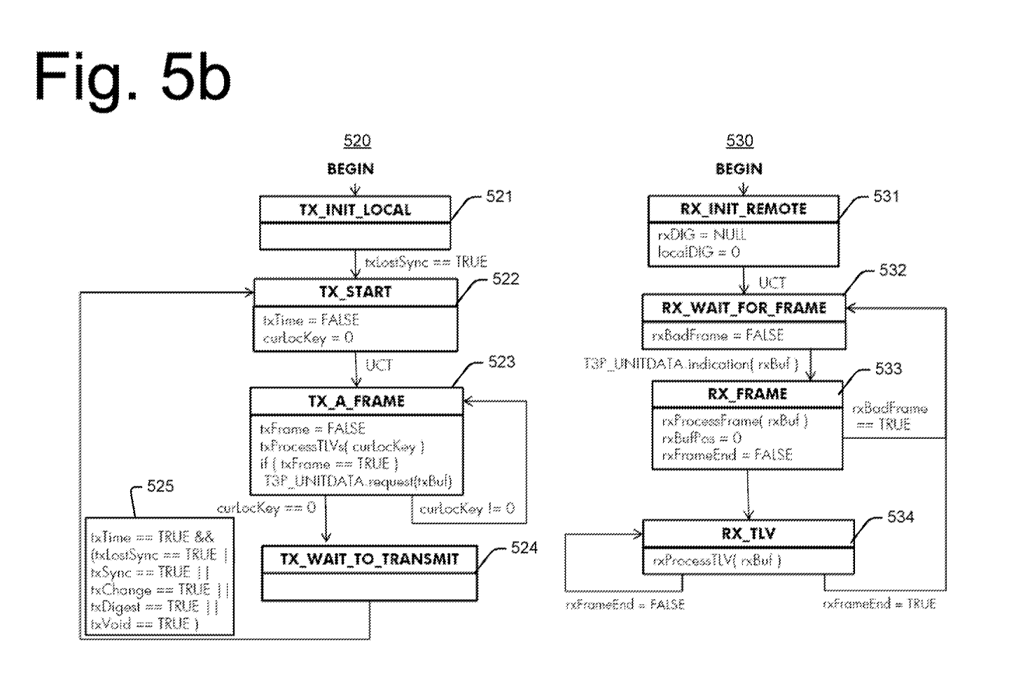

FIGS. 5a-b are state diagrams illustrating fast synchronization failure detection in distributed databases. FIG. 5a shows an example of operations 500 for synchronizing a local database, and an example of operations 510 for synchronizing a remote database 510. FIG. 5b shows an example of a transmit state machine 520 and an example of a receive state machine 530.

In FIG. 5a, the node initializes the local database at 501 (e.g., memory is cleared and a known database is built). The node then looks for LostSync from other nodes. The state machine loops at 502 until Sync is not True until Sync and DB is sent. The state machine then sends a digest and time of the digest until synchronization is lost again.

Also in FIG. 5a, the node initializes the remote database at 511 (e.g., memory is cleared and a known database is built). The node then initializes the digest at 512 and transmits a LostSync until a Sync is received. The state machine synchronizes the remote database at 513. The remote database remains in synch at 514 until a mismatch is detected, at which time the state machine loops back to 512.

In FIG. 5b, the transmit state machine 520 starts by initializing the local database at 521, and txLostSync is set to true by machine 510. The state machine starts at 522, builds a frame (e.g., a control TLV 525) at 523, and waits to transmit the frame at 524.

Also in FIG. 5b, the receive state machine 530 starts by initializing the remote database at 531. The state machine waits to receive a frame (e.g., a TLV) at 532. The receive state machine receives a frame at 533, and processes the frame at 534.

Before continuing, it is noted that the example dialogs shown in FIGS. 4a-d and the example state diagrams shown in FIGS. 5a-b are only shown for purposes of illustration, and are not intended to be limiting in any manner.

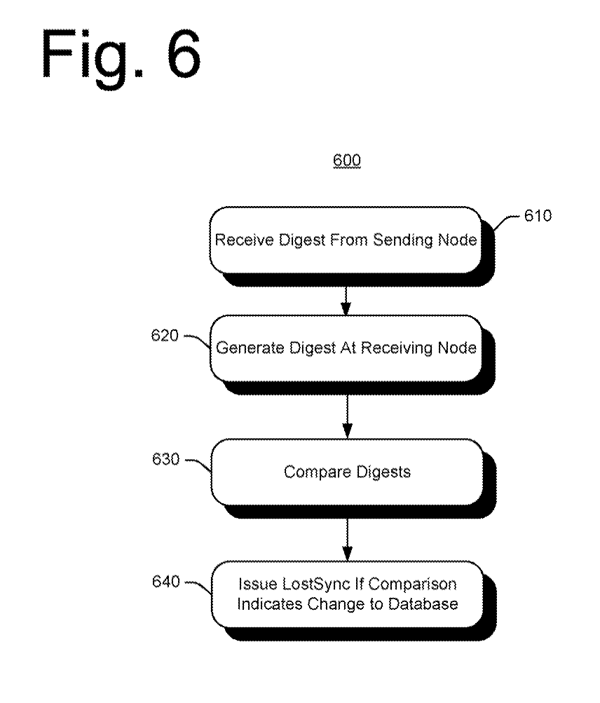

FIG. 6 is a flowchart illustrating exemplary operations which may be implemented for fast synchronization failure detection in distributed databases. Operations 600 may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used.

In operation 610, a digest of a database stored at a sending node in a network is received by a receiving node. The digest may be broadcast by the sending node to N number of nodes in the network, including the receiving node. In operation 620, a digest of a database stored at a receiving node in the network is generated.

It is noted that each node in the network may include a local feature database and a remote feature database. The remote database may include N number of elements corresponding to N number of nodes in the network. The digest of the database stored at the sending node is a digest of the local feature database, and the digest of the database generated at the receiving node is a digest of the remote feature database.

In an embodiment, the sending node and the receiving node may be a station node or a bridge node. The databases may include a plurality of Type Length Value (TLV) fields, each TLV corresponding to a feature.

In operation 630, the generated digest is compared at the receiving node to the received digest. In operation 640, a lost synchronization signal is issued by the receiving node when the comparison indicates a change in the database stored at the sending node.

The operations shown and described herein are provided to illustrate exemplary implementations of fast synchronization failure detection in distributed databases. It is noted that the operations are not limited to the ordering shown. Still other operations may also be implemented.

For example, the operations may also include issuing an update to the database stored at the receiving node only in response to receiving a lost synchronization signal from the receiving node. The operations may also include generating the digest by hashing each field of the database, and then XOR-ing all of the hashes. The operations may also include removing a field from the database at the receiving node by sending a VOID from the sending node.

It is noted that the exemplary embodiments shown and described are provided for purposes of illustration and are not intended to be limiting. Still other embodiments are also contemplated for fast synchronization failure detection in distributed databases.

1. A method of fast synchronization failure detection in distributed databases, comprising:
receiving a digest of a database stored at a sending node in a network, the digest broadcast by the sending node to N number of nodes in the network;
generating a digest of a database stored at a receiving node in the network;
comparing the generated digest to the received digest; and
issuing a lost synchronization signal by the receiving node when the comparison indicates a change in the database stored at the sending node.

2. The method of claim 1, wherein each node in the network includes a local feature database and a remote feature database.

3. The method of claim 2, wherein the remote database includes N number of elements corresponding to N number of nodes in the network.

4. The method of claim 3, wherein the digest of the database stored at the sending node is a digest of the local feature database, and the digest of the database generated at the receiving node is a digest of the remote feature database.

5. The method of claim 1, wherein the sending node and the receiving node are one of a station node or a bridge node.

6. The method of claim 1, wherein the databases are Link Layer Discovery Protocol (LLDP) feature databases.

7. The method of claim 1, wherein the databases include a plurality of Type Length Value (TLV) fields, each TLV corresponding to a feature.

8. The method of claim 1, further comprising issuing an update to the database stored at the receiving node only in response to receiving a lost synchronization signal from the receiving node.

9. The method of claim 1, wherein generating the digest is by hashing each field of the database, and then XOR-ing all of the hashes.

10. The method of claim 1, wherein a field is removed from the database at the receiving node by sending a VOID from the sending node.

11. A system for fast synchronization failure detection in distributed databases, comprising:
a first database agent at a first node in a network, the first database agent configured to generate a digest of a database stored at the first node, the digest broadcast to N number of nodes in the network; and
a second database agent at a second node in the network, the second database agent configured to compare a digest of a database stored at the second node with the digest received from the first node and issue a lost synchronization signal when the comparison indicates a change in the database.

12. The system of claim 11, wherein each node in the network includes a local feature database and a remote feature database.

13. The system of claim 12, wherein the remote database includes N number of elements corresponding to N number of nodes in the network.

14. The system of claim 13, wherein the digest of the database stored at the first node is a digest of the local feature database, and the digest of the database at the second node is a digest of the remote feature database.

15. The system of claim 11, wherein the first node and the second node are one of a station node or a bridge node.

16. The system of claim 11, wherein the databases are Link Layer Discovery Protocol (LLDP) feature databases.

17. The system of claim 11, wherein the databases include a plurality of Type Length Value (TLV) fields, each TLV corresponding to a feature.

18. The system of claim 11, wherein the database agent at the first node is configured to issue an update to the database stored at the second node in response to receiving a lost synchronization signal.

19. The system of claim 11, wherein the digests are generated by hashing each field of the database, and then XOR-ing all of the hashes.

20. The system of claim 11, wherein a field is removed from the database at the second node in response to a VOID from the first node.
